(19) United States
(12) Patent Application Publication
(10) Pub. No.: US 2025/0390402 A1
(43) Pub. Date: Dec. 25, 2025

(54) COMPUTING SYSTEM ATTESTATION

(71) Applicant: Hewlett Packard Enterprise Development LP, Spring, TX (US)

(72) Inventors: Nigel John Edwards, Bristol (GB); Theofrastos Koulouris, Bristol (GB); Geoffrey Ndu, Bristol (GB)

(21) Appl. No.: 18/747,550

(22) Filed: Jun. 19, 2024

(51) Int. Cl. G06F 11/22; G06F 21/44

(52) U.S. Cl. CPC G06F 11/2247; G06F 21/44

(57) ABSTRACT

In some examples, a verifier system receives, over a network from a computing system, attestation data including information from a data structure stored in a kernel integrity monitoring controller. The information includes a configuration value derived based on applying a function on monitoring configuration information, and an extended value derived based on extending a prior value in the data structure with a new value from a log recording changed measurements of the kernel information. The verifier system determines an integrity of the kernel information using the configuration value and the extended value for attestation of the computing system.

### BACKGROUND

An electronic device can include an operating system (OS) that manages resources of the electronic device. The resources include hardware resources, program resources, and other resources. The OS includes a kernel, which is the core of the OS and performs various tasks, including controlling hardware resources, arbitrating conflicts between processes relating to the resources, managing file systems, performing various services for parts of the electronic device, including other parts of the OS, and so forth.

### BRIEF DESCRIPTION OF THE DRAWINGS

Some implementations of the present disclosure are described with respect to the following figures.

FIG. 1 is a block diagram of an arrangement that includes computing systems and a verifier system according to some examples.

FIG. 2 is a flow diagram of an attestation data acquiring process according to some examples.

FIG. 3 is a flow diagram of a kernel tampering detection process according to some examples

FIG. 4 is a block diagram of a storage medium storing machine-readable instructions according to some examples.

FIG. 5 is a block diagram of a kernel integrity monitoring controller according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A kernel of an operating system (OS) may be corrupted or compromised. For example, malware may insert malicious code into the kernel or otherwise modify the kernel. The malicious code can be in the form of a malicious kernel module, which is an example of a rootkit. The rootkit can hide attacker activity and can have a long-term persistent presence in the OS. Alternatively, a kernel may be corrupted when errors are introduced into the kernel, such as due to malfunction of hardware or machine-readable instructions.

In some examples, a management controller such as a baseboard management controller (BMC) can run a kernel monitoring program to monitor the kernel in a computing system. The BMC includes a network interface to allow the BMC to communicate over a management network, which may be in addition to a production network over which the computing system communicates data with other entities during normal operations of the computing system. If the kernel monitoring program on the BMC detects an integrity violation of the kernel, the kernel monitoring program issues an alert over the management network to a target entity, such as an administrator or other user, a remote management system, or any other entity.

However, in some cases, the BMC may not be connected to a management network. For example, the network interface of the BMC may not be physically connected to a management network. As another example, a target entity that relies on kernel integrity violation alerts provided by the BMC may not be reachable over the management network. In either case, the BMC may not be able to send an alert of a kernel integrity violation to the target entity. The target entity may be responsible for determining a root cause of the kernel integrity violation, or for ensuring that an appropriate remediation is taken to address the kernel integrity violation. If the BMC is unable to reach the target entity for notifications of kernel integrity violations, then actions to address the kernel integrity violation and prevent further damage or errors in the computing system may not be taken.

In accordance with some implementations of the present disclosure, attestation of runtime kernel information of a kernel executing on a central processing unit (CPU) of a computing system can be performed by a verifier system based on attestation data from a kernel integrity monitoring controller, where the attestation data includes information from a data structure stored in a kernel integrity monitoring controller. In some examples, the data structure can include a collection of registers, such as platform configuration registers (PCRs). In other examples, the data structure can be a different type of data container of information, which may be stored in a memory. The information from the data structure includes: a configuration value derived by applying a function on monitoring configuration information; an extended value based on extending a prior value in the data structure with a new value from a log recording changed measurements of the kernel information; and other values. The monitoring configuration information specifies a configuration for monitoring the kernel information associated with the kernel. The verifier system determines an integrity of the kernel information using the configuration value and the extended value, and possibly other values in the attestation data.

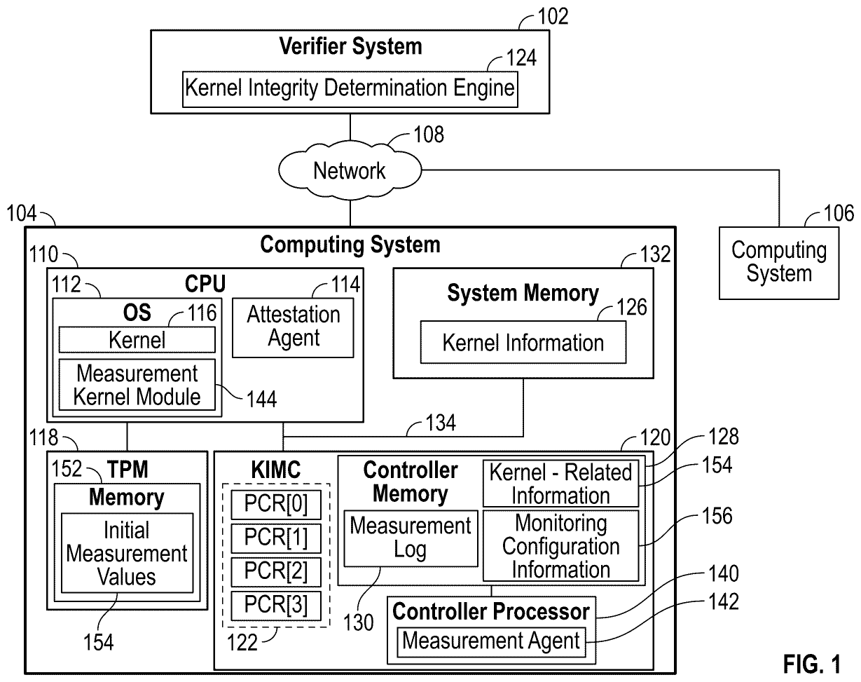

FIG. 1 is a block diagram of an example arrangement that includes a verifier system 102 and computing systems 104 and 106 running OS kernels that can be verified by the verifier system 102 based on attestation data received from the respective computing systems 104 and 106. The verifier system 102 is connected over a network 108 to the computing systems 104 and 106. The network 108 can include a public network such as the Internet, a wide area network (WAN), a local area network (LAN), or another type of network.

The verifier system 102 can be implemented using one or more computers. Although two computing systems are shown in FIG. 1, in other examples, the verifier system 102 can be used to verify the OS kernel in just one computing system, or in more than two computing systems. FIG. 1 shows components in the computing system 104. The computing system 106 may include a similar arrangement of components.

The computing system 104 includes a central processing unit (CPU) 110, which includes one or more hardware processors. The CPU 110 can run machine-readable instructions of the computing system 104, including an OS 112 and an attestation agent 114. The machine-readable instructions executed by the CPU 110 are initially stored in a storage medium (not shown in FIG. 1) and loaded for execution on the CPU 110. In some examples, the OS 112 is a host OS running directly on the CPU 110. In other examples, the OS 112 is a guest OS running in a virtual machine (VM).

The OS 112 includes a kernel 116. During execution of the kernel 116 on the CPU 110, kernel modules can be loaded by the kernel 116. One of these kernel modules is a measurement kernel module 144 that supports measurements of kernel information 126 related to the kernel 116. The kernel information 126 is stored in a system memory 132 (including one or more memory devices) of the computing system 104. The kernel information 126 includes runtime kernel information created during execution of the kernel 116 on the CPU 110.

The kernel information 126 can include any or some combination of the following: executable code of the kernel 116; identifiers of allowed kernel modules that are to be loaded by the kernel 116; kernel read-only data that includes data used by the kernel 116, where the data is not expected to be changed; kernel data structures that should be invariant during runtime unless an error has occurred (an example kernel data structure identifies a list of loaded kernel modules and specifies other information related to calls (e.g., system call table) made of functions by the kernel 116); and other kernel information.

The computing system 104 also includes a trusted platform module (TPM) 118. The TPM 118 is an example of a security processor (also referred to as a security cryptoprocessor) that can perform various hardware-based, security functions in the computing system 104. The security functions of the TPM 118 can include key management and generation to generate cryptographic keys used in security operations.

The computing system 104 also includes a kernel integrity monitoring controller (KIMC) 120 according to some examples of the present disclosure. The KIMC 120 in some examples have no access to a network to which a target entity for receiving alerts of kernel integrity violations is connected. Therefore, even if the KIMC 120 detects a kernel integrity violation, the KIMC 120 is unable to directly notify the target entity.

In some examples, the KIMC 120 is implemented using a management controller such as a BMC. In other examples, the KIMC 120 is implemented using other controllers, including microcontrollers, a processor of a CPU assembly or superchip, or any other hardware processing circuitry. The KIMC 120 is separate from the CPU 110. In examples where the KIMC 120 is implemented using a processor of a CPU assembly, the CPU assembly includes the CPU 110 and a separate processor, where the separate processor implements the KIMC 120. Although machine-readable instructions executed on the CPU 110 are able to communicate over the network 108 (to which a target entity may be connected), the separate processor of the CPU assembly does not have access to the network 108 (e.g., due to isolation of the separate processor from the network 108).

The KIMC 120 is connected over an interconnect 134 to the CPU 110 and the system memory 132. Although FIG. 1 shows a direct connection of the KIMC 120 to each of the CPU 110 and the system memory 132, it is noted that there may be one or more intermediate devices (e.g., bridge devices, controller hubs, etc.) between the KIMC 120 and the CPU 110 and/or the system memory 132. The interconnect 134 can be any of the following types of interconnects: a Compute Express Link (CXL) interconnect, a Peripheral Component Interconnect Express (PCIe) interconnect, or another type of communication link.

In accordance with some examples of the present disclosure, the attestation agent 114 executed on the CPU 110 is used to obtain attestation data from the KIMC 120, and the attestation agent 114 provides, over the network 108, the attestation data to a kernel integrity determination engine 124 in the verifier system 102. The kernel integrity determination engine 124 in the verifier system 102 makes a determination of an integrity of the kernel information 126 based on the attestation data provided by the attestation agent 114. Thus, even though the KIMC 120 is unable to access the network 108, attestation data of the KIMC 120 can be obtained by the attestation agent 114 and provided to the verifier system 102 over the network 108. The attestation data obtained from the KIMC 120 can include a measurement log 130, values in a data structure 122, and other information as discussed further below.

In some examples, the KIMC 120 is able to perform direct memory access (DMA) of the system memory 132 over the interconnect 134. A DMA of a memory refers to the ability to read or write data of the memory without using the CPU 110. Using DMA, the KIMC 120 is able to retrieve the kernel information 126 from the system memory 132 to perform measurements on the kernel information 126. More specifically, measurements are performed of memory regions of the memory that contain the kernel information 126. The measurements by the KIMC 120 produce measurement values, such as cryptographic hash values, based on portions of the kernel information 126. The portions of the kernel information 126 can be stored in respective memory regions of the system memory 132.

A cryptographic hash value for the kernel information 126 is generated by applying a cryptographic hash function (e.g., a Secure Hash Algorithm (SHA) function) on the kernel information 126. The cryptographic hash function produces the corresponding cryptographic hash value.

The measurement kernel module 144 invoked by the kernel 116 provides, to the KIMC 120, target storage location information of one or more memory regions in the system memory 132 in which the kernel information 126 is stored. In some examples, the target storage location information provided by the measurement kernel module 144 to the KIMC 120 includes target memory address(es) of the memory region(s) of the system memory 132 containing the kernel information 126. Such memory region(s) is (are) to be monitored by the KIMC 120 for kernel integrity measurements. A target memory address of a memory region to be monitored by the KIMC 120 can include a physical memory address or a virtual memory address. The KIMC 120 uses the target storage location information from the measurement kernel module 144 to retrieve kernel information from the identified memory region(s).

In addition, the measurement kernel module 144 can send initial load-time measurements of the kernel information 126 to the KIMC 120. When the kernel 116 is initially loaded (e.g., during a boot or startup sequence of the computing system 104), an initial version of the kernel information 126 is written to the system memory 132. Note that the kernel information 126 should not change from this initial version, unless an authorized maintenance or upgrade made changes to the kernel information 126. The initial load-time measurements of the kernel information 126 represent the initial boot state of the computing system 104.

The computing system 104 is able to perform a measured and secure boot of the kernel 116. The measured boot is accomplished by verifying that the machine-readable instructions of the kernel 116 have not been tampered with, such as based on confirming that cryptographic hash values computed based on the machine-readable instructions of the kernel 116 match expected cryptographic hash values. A secure boot involves verifying a signature associated with the machine-readable instructions of the kernel 116. The secure boot ensures that authorized program code is booted, while the measured boot ensures that the correct program code (e.g., a specific version of the kernel 116) is being booted.

After the initial loading of the kernel 116, the measurement kernel module 144 is able to perform the initial load-time measurements of the kernel information 126. These initial load-time measurements of the kernel information 126 are taken during a time when the computing system 104 is relatively secure. The initial load-time measurements can be stored by the measurement kernel module 144 as initial measurement values 150 in a memory, such as the system memory 132 or a secure memory 152 of the TPM 118. The measurement kernel module 144 can provide the initial measurement values 150 as the initial load-time measurements to the KIMC 120. The KIMC 120 uses the initial load-time measurements to detect if the kernel information 126 has been modified from the initial version of the kernel information 126 written to the system memory 132 with the initial loading of the kernel 116.

The initial measurement values (e.g., cryptographic hash values) received from the measurement kernel module 144 are stored as part of kernel-related information 154 in a controller memory 128 in the KIMC 120. The KIMC 120 can also store the received target storage location information of the kernel information 126 in the kernel-related information 154. The controller memory 128 is separate from the system memory 132.

The KIMC 120 includes a controller processor 140, which executes a measurement agent 142 (implemented using machine-readable instructions) to measure the kernel information 126, such as by applying the cryptographic hash function on the kernel information 126. The measurement agent 142 uses the target storage location information provided by the measurement kernel module 144 to retrieve the kernel information 126 (such as by performing DMA accesses) from the system memory 132.

The controller memory 128 stores the measurement log 130, which is used to record measurement changes relating to measurements of the kernel information 126 by the measurement agent 142. The measurement agent 142 can access the kernel information 126 periodically or in response to specified events (e.g., an event indicating an error condition, an event indicating possible intrusion, etc.) to measure the kernel information 126. The measurement agent 142 compares new measurement values (e.g., cryptographic hash values) generated based on a current measurement of the kernel information 126 to the initial measurement values in the kernel-related information 154.

If a change in a portion of the kernel information 126 is detected based on comparing the new measurement values to the initial measurement values, the measurement agent 142 logs this detected change as an entry in the measurement log 130. Each entry includes a new measurement value (of the portion of the kernel information 126 that has changed) and storage range information identifying a memory segment in the system memory 132 containing the kernel information portion that was modified. The storage range information can include a memory address range, such as a starting memory address and an ending memory address, or a starting memory address and a length of the kernel information portion.

The measurement log 130 can have any of various different forms, such as in the form of a table, a text file, or any other form. As changes to the kernel information 126 are detected by the measurement agent 142, the measurement agent 142 adds corresponding entries to the measurement log 130, where the entries contain new measurement values and identify the kernel information portions that have changed (or more specifically, identify the memory ranges in the system memory 132 containing the kernel information portions that have changed).

In accordance with some examples of the present disclosure, the KIMC 120 further includes the data structure 122 that stores values that are included in attestation data provided to the kernel integrity determination engine 124 in the verifier system 102 to determine an integrity of kernel information 126. In some examples, the data structure can be implemented using PCRs, including PCR[0], PCR[1], PCR[2], and PCR[3]. Although a specific quantity of PCRs is depicted in FIG. 1, in a different example, the data structure 122 can include a different quantity of PCRs (e.g., less than four PCRs or more than four PCRs). In other examples, the data structure 122 can be implemented using a different type of data container, such as a database table or any other type of data container. Although FIG. 1 shows the PCRs as being separate from the controller memory 128 of the KIMC 120, in some examples, the PCRs may be stored in the controller memory 128. Alternatively, the PCRs can be implemented using respective physical registers.

In examples where PCR[0], PCR[1], PCR[2], and PCR[3] are part of a BMC, then these PCRs are PCRs not already allocated in a Trusted Computing Group (TCG) Specification for BMCs. Note further that the KIMC 120 can execute a measured and secure boot of machine-readable instructions (including firmware) of the KIMC 120. Some PCRs in the KIMC 120 may be allocated for the KIMC's measured boot. PCR[0], PCR[1], PCR[2], and PCR[3] are separate from the PCRs allocated for the KIMC's measured boot.

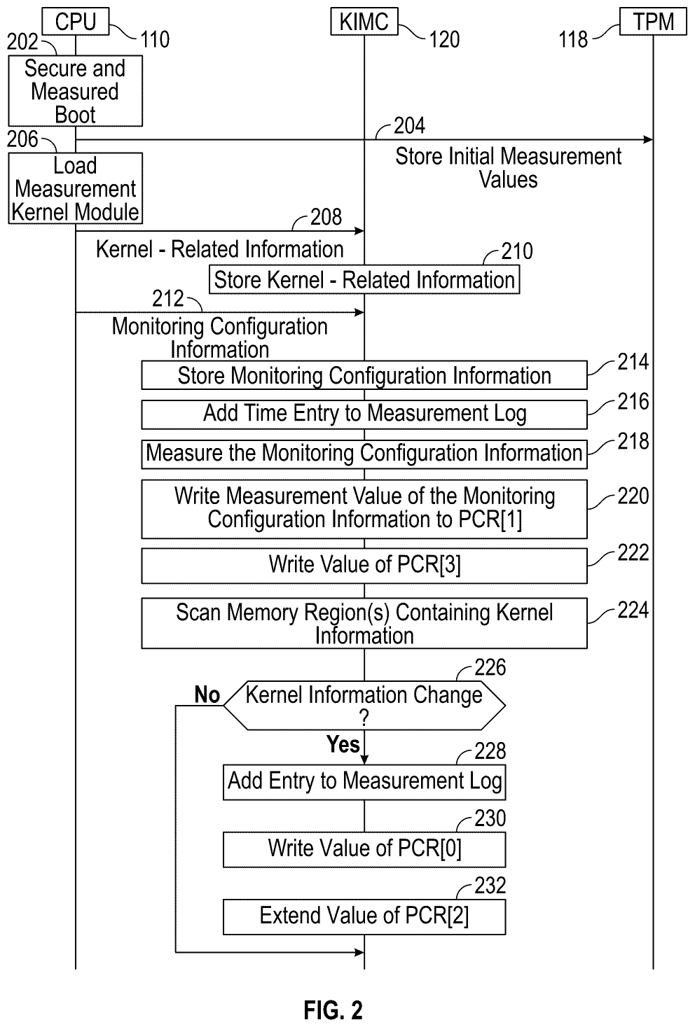

FIG. 2 is a flow diagram of a process performed in the computing system 104 according to some examples of the present disclosure. Although FIG. 2 shows tasks performed in a given order, note that the tasks may be performed in a different order, some tasks may be omitted, and other tasks may be added.

Upon starting (e.g., due to a reboot or power on of the computing system 104), the CPU 110 (or more specifically, boot code on the CPU 110) performs a secure and measured boot (at 202) of the kernel 116, in which initial load-time measurements of the kernel information 126 are taken and stored (at 204) in a secure memory, such as the initial measurement values 150.

The kernel 116 loads (at 206) the measurement kernel module 144 (along with other kernel modules, such as those identified in the kernel information 126). The measurement kernel module 144 running on the CPU 110 sends (at 208) kernel-related information to the KIMC 120, where the kernel-related information includes the initial load-time measurements and the target storage location information of the kernel information 126. The KIMC 120 stores (at 210) the kernel-related information 154 in the controller memory 128.

In some examples, the attestation agent 114 (or another entity) can provide (at 212) monitoring configuration information to the KIMC 120, which stores (at 214) the monitoring configuration information 156 in the controller memory 128. The monitoring configuration information 156 specifies a configuration relating to scanning of the kernel information 126. For example, the monitoring configuration information 156 includes an “allowed list” of kernel modules, which identifies one or more kernel modules that are dynamically loadable by the kernel 116 without triggering the KIMC 120 to indicate a potential error condition in the data structure 122. In other words, the kernel module(s) identified by the allowed list in the monitoring configuration information 156 are the allowed kernel module(s). As a kernel module is loaded by the kernel 116, information of the kernel module is added to the kernel information 126. Further, the monitoring configuration information 156 can specify a scanning condition for measurement of the kernel information 126. The scanning condition can include a scanning frequency for measurement of the kernel information 126 by the measurement agent 142 in the KIMC 120. The scanning frequency specifies the periodicity at which the measurement agent 142 is to measure the kernel information 126. Alternatively or additionally, the scanning condition can include a measurement triggering event (e.g., an error event, a potential intrusion event, etc.) that triggers a measurement of the kernel information 126. One the KIMC 120 receives the monitoring configuration information 156, the KIMC 120 may not accept another instance of the monitoring configuration information unless a system reset takes place.

In some examples, in response to receiving the monitoring configuration information from the attestation agent 114, the KIMC 120 adds (at 216) a time entry to the measurement log 130. The time entry contains time information (e.g., number of milliseconds or number of time epochs) indicating an amount of time that has transpired from a start time of the KIMC 120 (the time at which the KIMC 120 started operation) and a time at which the KIMC 120 activates kernel information monitoring based on the monitoring configuration information. The time information in the time entry can be used to detect an attacker attempting to delay monitoring of the kernel information 126 in order to modify the kernel 116 before monitoring starts.

In some examples, entries can be added to the measurement log 130 on a line-by-line basis, where an end-of-line indicator is used to indicate a boundary between different entries. In other examples, a different separation indicator, such as a separation tag, can be used to identify different entries in the measurement log 130.

The measurement agent 142 measures (at 218) the monitoring configuration information 156 to generate a measurement value of the monitoring configuration information 156. For example, the measurement agent 142 applies a cryptographic hash function to the monitoring configuration information 156 to produce a cryptographic hash value. Note that the measurement of the monitoring configuration information 156 can be performed when the KIMC 120 initially starts, and in response to any change in the monitoring configuration information 156. The measurement agent 142 writes (at 220) the measurement value of the monitoring configuration information 156 in PCR[1] of the data structure 122. The measurement value in PCR[1] is used to confirm that an attacker has not modified the monitoring configuration performed by the KIMC 120.

The KIMC 120 also writes (at 222) a value of PCR[3] of the data structure 122 based on whether kernel information monitoring is active. If kernel information monitoring is active (which means that the KIMC 120 measures the kernel information 126 according to the monitoring configuration information 156), the KIMC 120 sets PCR[3] to an “active” value (e.g., “0” or a different value). On the other hand, if kernel information monitoring is inactive (which means that the KIMC 120 does not measure the kernel information 126), the KIMC 120 sets PCR[3] to an “inactive” value (e.g., a non-zero value or any other value different from the “active” value).

Assuming kernel information monitoring is active, and assuming a scanning condition specified by the monitoring configuration information 156 is satisfied, the measurement agent 142 scans (at 224) the memory region(s) of the system memory 132 identified by the target storage location information to generate new measurement values (including cryptographic hash values) of the kernel information 126. The measurement agent 142 determines (at 226) whether the kernel information 126 has changed based on comparing the new measurement values with the initial measurement values (e.g., the initial load-time measurement values received from the measurement kernel module 144). If the compared measurement values do not match, then a change of the kernel information 126 has occurred. Note that the measurement agent 142 can disregard changes of the kernel information 126 due to loading of allowed kernel modules identified by the allowed list in the monitoring configuration information 156.

If the measurement agent 142 determines (at 226) that the kernel information 126 has changed (other than changes due to loading of allowed kernel modules identified by the allowed list), the measurement agent 142 performs tasks 228, 230, and 232. If the measurement agent 142 determines (at 226) that the kernel information 126 has not changed, then no entry is added to the measurement log 130, and the tasks 228, 230, and 232 are skipped.

The measurement agent 142 adds (at 228) an entry to the measurement log 130. The added entry includes a new measurement value (of the portion of the kernel information 126 that has changed) and storage range information identifying a memory segment in the system memory 132 containing the kernel information portion that was changed.

Additionally, the measurement agent 142 writes (at 230) a value to PCR[0] of the data structure 122 to indicate that a change in the kernel information 126 has been detected. Initially, such as when the KIMC 120 initially starts, PCR[0] may be set at a “good” value (e.g., “0” or another value) to indicate that no modification of the kernel information 126 has been detected. In response to determining (at 226) that the kernel information 126 has changed, the measurement agent 142 sets PCR[0] to a “modified” value (e.g., a non-zero value or any other value different from the “good” value) to indicate that a modification of the kernel information 126 has been detected. Once PCR[0] is set to the “modified” value, PCR[0] stays at the “modified” value until the computing system 104 is reset and the KIMC 120 is restarted. Reset of the computing system 104 causes the CPU 110 to perform another secure and measured boot for ensuring that the kernel information 126 has not been compromised.

The measurement log 130 is relatively small (e.g., on the order of a few kilobytes or some other size). If the measurement log 130 becomes full, the measurement agent 142 will not record any more changes of the kernel information 126 to the measurement log 130, and the measurement log 130 will remain unchanged and PCR[0] remains set with the “modified” value until system reset occurs.

Further, the measurement agent 142 extends (at 232) the value in PCR[2] of the data structure 122. Note that PCR[2] is reset to an initial value (e.g., “0” or another value) when the KIMC 120 starts. The measurement agent 142 extends PCR[2] by performing an extend operation that calculates a cryptographic hash of a combination of the current value in PCR[2] with new data (“digest value”). The digest value is a measurement value (e.g., cryptographic hash value) based on applying a function (e.g., a cryptographic hash function) on the measurement log 130. As entries are added to the measurement log 130, measurement values of the measurement log 130 will change.

The measurement agent 142 uses the result of the cryptographic hash as the new value stored in PCR[2]. More specifically, if PCR[2] contains a current value (Current PCR Value), then the new value (New PCR Value) to be stored to PCR[2] is computed according to Eq. 1 below:

$$New PCR Value = H ( Digest Value ‖ Current PCR Value ) , \qquad ( Eq . 1 )$$

where H( ) is a cryptographic hash function, and the ∥ operator represents a concatenation. New PCR Value then becomes the updated Current PCR Value of PCR[2], and any subsequent detected changes of the kernel information 126 would result in an update of PCR[2] using the updated Current PCR Value according to Eq. 1.

The measurement log 130 thus 4 PCRs associated with monitoring the kernel information 126, as summarized in Table 1 below.

TABLE 1

| PCR | Value |
|---|---|
| PCR[0] | “Good” or “Modified” |
| PCR[1] | Hash value of monitoring configuration |
| | information 156 |
| PCR[2] | Extended hash of measurement log 130 |
| PCR[3] | “Active” or “Inactive” |

The KIMC 120 is notified by the attestation agent 114 (or another entity) of a CPU reset when the CPU 110 is reset (which also means that the TPM 118 has been reset). In response to receiving notification of the CPU reset, the KIMC 120 can reset PCR[0], PCR[1], PCR[2], and PCR[3] to their initial values, e.g., PCR[0]=“good,” PCR[1]=0 or another initial value, PCR[2]=0 or another initial value, and PCR[3]=“inactive.” The CPU reset would cause a reload of the kernel 116 that is to be monitored again by the KIMC 120.

In some examples, if the measurement kernel module 144 is not run (i.e., not loaded by the kernel 116) and no monitoring configuration information 156 is received by the KIMC 120, then the measurement log 130 will not have any entries (except possibly the time entry noted above). As a result, PCR[0] will have a “good” value, each of PCR[1] and PCR[2] will be set at an initial value, and PCR[3] will be set to the “inactive” value.

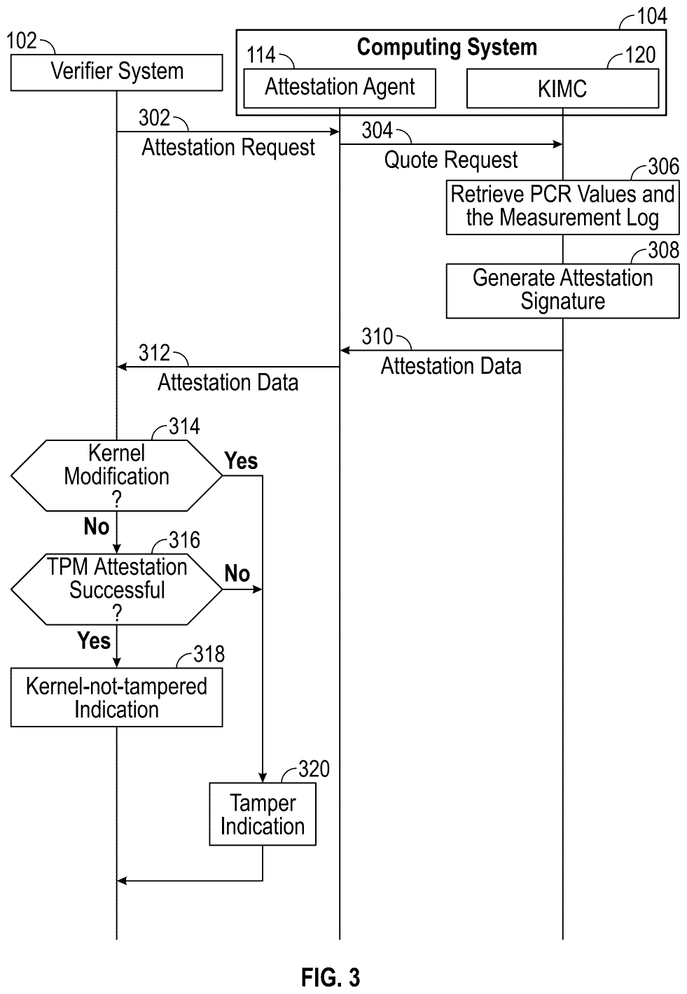

FIG. 3 is a flow diagram of a process performed by the verifier system 102 and the computing system 104 according to some examples of the present disclosure. Although FIG. 3 shows tasks performed in a given order, note that the tasks may be performed in a different order, some tasks may be omitted, and other tasks may be added.

In some examples, the verifier system 102 can initiate an attestation of the computing system 104. For example, the verifier system 102 sends (at 302) an attestation request (e.g., a message, an information element, or any other indicator) to the attestation agent 114 in the computing system 104. The attestation request can include a verifier-provided nonce (nonceᵢ), which is a random number generated by the kernel integrity determination engine 124 in the verifier system 102, for example.

The verifier system 102 sends the attestation request to the attestation agent 114 if a pull model is employed, in which the verifier system 102 initiates the attestation of a computing system. In other examples, a push model may be employed, in which the attestation agent 114 can push attestation data to the verifier system 102 without the attestation agent 114 being requested by the verifier system 102.

In response to the attestation request, the attestation agent 114 sends (at 304) a quote request to the KIMC 120. The quote request (which can be analogous to a TPM quote request) refers to any indication that the attestation agent 114 is requesting attestation data from the KIMC 120 for the purpose of verifying the kernel information 126.

In other examples, a different type of request can be issued by the attestation agent 114 to the KIMC 120 for attestation data. For example, the request can include a “GET_MEASUREMENTS” request according to the Distributed Management Task Force (DMTF) Security Protocols and Data Models (SPDM) protocol.

The quote request includes the verifier-provided nonce (nonceᵢ) and a key index (kᵢ) that identifies an attestation key (AK) to be used in generating a signature at the KIMC 120. The attestation key may be an initial attestation key (IAK) or a local attestation key (LAK) used as part of an attestation procedure.

In response to the quote request, the KIMC 120 retrieves (at 306) values in the PCRs of the data structure 122 and information in the measurement log 130. The KIMC 120 also generates (at 308) an attestation signature (sigₒ) as follows:

$${sig}_{0} = Signature ( {k}_{i} , {nonce}_{i} , {nonce}_{o} , PCR [ 0 , 1 , 2 , 3 ] ) ,$$

where nonceₒ is a nonce (e.g., a random number) generated by the KIMC 120, and Signature( ) is a signature function, such as a Rivest-Shamir-Adleman (RSA) function. The attestation signature is used by the kernel integrity determination engine 124 to authenticate the attestation data.

The KIMC 120 produces an attestation output that contains the following attestation data: nonceₒ, PCR[0, 1, 2, 3], measurement log 130, sigₒ. The KIMC 120 sends (at 310) the attestation data to the attestation agent 114. The attestation data can be transferred from the KIMC 120 to the attestation agent 114 in one transfer operation or in multiple transfer operations. In response, the attestation agent 114 sends (at 312) the attestation data to the verifier system 102 over the network 108.

The kernel integrity determination engine 124 in the verifier system 102 determines (at 314), based on the attestation data, whether modification of the kernel information 126 has occurred. If the KIMC 120 has not detected any changes to the kernel information 126 from the initial boot state, PCR[0] is set to the “good” value (indicating no kernel information change was detected), PCR[3] is set to the “active” value (indicating that kernel information monitoring is active), PCR[1] is set to the hash of the monitoring configuration information 156, and PCR[2] is set to the hash of the measurement log 130 (such as the hash of the time entry in the measurement log 130 since no further entries indicating changes to the kernel information 126 were added). If PCR[0]=“good,” PCR[3]=“active,” and the kernel integrity determination engine 124 confirms that the monitoring configuration information 156 is valid based on comparing the hash in PCR[1] to an expected hash value (stored at the verifier system 102) representing a valid monitoring configuration information, then that indicates to the to the kernel integrity determination engine 124 that the KIMC 120 has not detected a kernel information change.

However, even if the attestation data indicates no modification of the kernel information 126 (“No” branch of the decision diamond 314), it is still possible that the computing system 104 has been compromised. In some examples, the kernel integrity determination engine 124 further determines (at 316) whether a TPM attestation with the TPM 118 is successful to confirm that the computing system 104 was initialized correctly. The TPM attestation includes validating a signature of data in the TPM 118 using an attestation key.

If the TPM attestation is successful (as determined at 316), the kernel integrity determination engine 124 provides (at 318) a kernel-not-tampered indication that the kernel information 126 has not been tampered with. The kernel-not-tampered “indication” can be in the form of a signal, a message, an information element, or any other indicator.

However, if the TPM attestation is unsuccessful (the “No” branch from the decision diamond 316), the kernel integrity determination engine 124 provides (at 320) a tamper indication that the kernel information 126 has been tampered with. Tasks 314 and 316 are part of an example process of determining the integrity of the kernel information 126 using attestation data provided by the KIMC 120.

The following are examples of conditions under which the kernel integrity determination engine 124 determines (at 314) that tampering of the kernel information 126 has occurred based on the attestation data (the “Yes” branch of the decision diamond). In an example, if the hash in PCR[1] does not match the expected hash value, then the monitoring configuration information 156 has been modified (i.e., no longer valid). Modification of the monitoring configuration information 156 indicates that tampering of the kernel information 126 may have occurred. For example, an attacker can modify the monitoring configuration information 156 to add an unauthorized kernel module. As noted above, the monitoring configuration information 156 can identify kernel modules that are allowed. If the monitoring configuration information 156 identifies the unauthorized kernel module, then the unauthorized kernel module can be loaded by a compromised kernel and the KIMC 120 would not indicate a change of the kernel information 126 based on the loading of the unauthorized kernel module.

In another example, if PCR[0]=“modified” (which indicates that the KIMC 120 has detected a change of the kernel information), then PCR[2] would contain an extended hash of the entries in the measurement log 130. To verify the authenticity of the measurement log 130, the kernel integrity determination engine 124 replays the measurement log 130 that is received from the KIMC 120 as part of the attestation data. Replaying the measurement log 130 refers to computing cryptographic hashes of the entries of the measurement log 130 by the kernel integrity determination engine 124 and extending the hash values. If the extended hash value produced by the kernel integrity determination engine 124 matches the hash value in PCR[2], then that confirms the measurement log 130 is valid (i.e., has not been tampered with). If the extended hash value produced by the kernel integrity determination engine 124 does not match the hash value in PCR[2], then that indicates that tampering of the measurement log 130 may have occurred.

Assuming the measurement log 130 is valid, the kernel integrity determination engine 124 checks whether any changes indicated by the entries of the measurement log 130 are unauthorized. As noted above, each entry of the measurement log 130 includes a measurement value (of the portion of the kernel information 126 that has changed) and storage range information identifying a memory segment in the system memory 132 containing the kernel information portion that was modified. In some cases, an administrator may have authorized a change to the kernel 116, such as by replacing, adding, or removing kernel modules. The kernel integrity determination engine 124 determines whether the changed kernel information portion matches the expected kernel changes. If not, that indicates tampering of the kernel information 126 has occurred.

The kernel integrity determination engine 124 also checks the size of the measurement log 130. The measurement log 130 has a maximum size. If entries fill up the measurement log 130 to the maximum size, then it is possible additional changes were detected by the KIMC 120 but not recorded in the measurement log 130. If the measurement log 130 is at the maximum size, the kernel integrity determination engine 124 indicates possible tampering of the kernel information 126 has occurred.

As a further example, if PCR[0]=“good” but PCR[3]=“inactive” (indicating that kernel information monitoring is inactive), then that indicates the KIMC 120 was unable to scan the kernel information 126. For example, an I/O memory management unit (IOMMU) of the computing system 104 may block the KIMC 120 from performing a DMA of the system memory 132. IOMMU is a technology that connects a DMA-capable interconnect to system memory, which in this case is the system memory 132. An attacker may configure a setting of the IOMMU to block the KIMC 120 from accessing the system memory 132, which would prevent scanning of the kernel information 126 in the system memory 132 by the KIMC 120 even though the KIMC 120 received target storage location information of one or more memory regions in the system memory 132 in which the kernel information 126 is stored. In some examples, the KIMC 120 can add an entry to the measurement log 130 that contains information indicating that system memory access was blocked. The kernel integrity determination engine 124 can detect such an entry in the measurement log 130 to determine whether the blocking of the access of the system memory 132 was authorized. If not, then the kernel integrity determination engine 124 can determine that tampering of the kernel information 126 has occurred.

In further examples, if settings of the IOMMU are changed frequently that resulted in the measurement log 130 being filled (to the maximum size) with the entries indicating that the KIMC 120 is blocked from accessing the system memory 132, the KIMC 120 can change the value of PCR[0] to “modified,” which can alert the kernel integrity determination engine 124 of a potential kernel information modification condition indicating possible tampering of the kernel information 126.

In response to any of the foregoing conditions indicating possible tampering of the kernel information 126, the kernel integrity determination engine 124 provides (at 320) a tamper indication that the kernel information 126 has been modified.

The tamper indication can trigger the verifier system 102 to perform one or more remediation actions, including any or some combination of the following: alert a target entity, disable the computing system 104 by shutting down the computing system 104 or disabling a network interface of the computing system 104, disabling writes in the computing system 104, or any other remediation action.

In some examples, the kernel integrity determination engine 124 can also validate the KIMC 120 to verify that the KIMC 120 can be trusted. The KIMC 120 may provide an interface, such as an application programming interface (API), that allows the kernel integrity determination engine 124 to retrieve a certificate (e.g., an IAK or LAK certificate) from the KIMC 120. If the KIMC 120 has been tampered with, the KIMC's certificate will not be valid based on a check using an AK by the kernel integrity determination engine 124. If the KIMC's certificate is not valid, then the kernel integrity determination engine 124 does not trust the attestation data from the KIMC 120, and the kernel integrity determination engine 124 can provide a tamper indication.

As noted above, there is a delay between a start time of the KIMC 120 and a time at which the KIMC 120 activates kernel information monitoring based on the monitoring configuration information. This delay is represented in the time entry of the measurement log 130, and the delay provides a window of opportunity for an attacker to compromise the computing system 104. To mitigate the monitoring delay issue, the KIMC 120 begins initially scanning the kernel information when started (even before receipt of the monitoring configuration information 156). At this point, since the KIMC 120 does not yet have the monitoring configuration information 156, the KIMC 120 does not know which kernel modules are valid; as a result, initially, the KIMC 120 accepts all kernel modules as valid. During the initial scanning of the kernel information 126, the KIMC 120 can flag a modification (by setting PCR[0] to the “modified” value) if the KIMC 120 detects that kernel executable code or read-only data has been modified (from the initial boot state). After the monitoring configuration information 156 is loaded, the KIMC 120 can rescan the kernel information 126 to determine if any kernel modules are not allowed.

In addition, the kernel integrity determination engine 124 can check if the delay represented by the time entry in the measurement log 130 exceeds a threshold. If so, the kernel integrity determination engine 124 can indicate a potential tamper condition with the kernel 116.

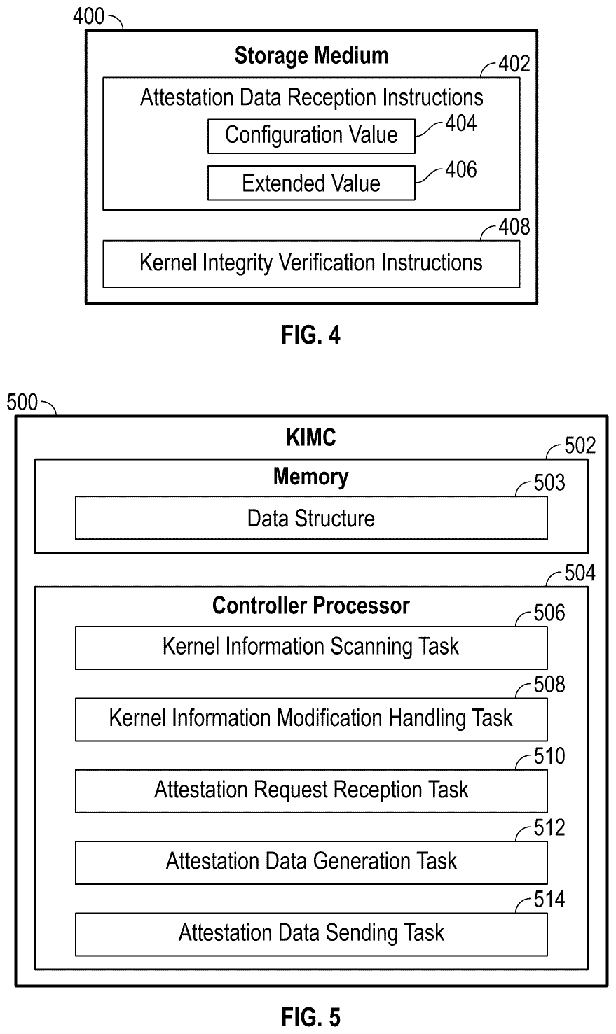

FIG. 4 is a block diagram of a non-transitory machine-readable storage medium 400 storing machine-readable instructions that upon execution cause a verifier system to perform various tasks. The verifier system can be the verifier system 102 of FIG. 1.

The machine-readable instructions include attestation data reception instructions 402 to receive, at the verifier system over a network from a computing system (e.g., 104 or 106 in FIG. 1), attestation data including information from a data structure stored in a kernel integrity monitoring controller (e.g., 120 in FIG. 1). The received attestation data includes a configuration value 404 derived based on applying a function on monitoring configuration information. An example of the configuration value 404 is included in PCR[1] in FIG. 1. The monitoring configuration information specifies a configuration for monitoring kernel information associated with a kernel executing on a CPU (e.g., 110 in FIG. 1) of the computing system. The CPU is separate from the kernel integrity monitoring controller.

The attestation data further includes an extended value 406 derived based on extending a prior value in the data structure with a new value from a log (e.g., the measurement log 130 in FIG. 1) recording changed measurements of the kernel information. An example of the extended value 406 is included in PCR[2] in FIG. 1.

The machine-readable instructions include kernel integrity verification instructions 408 to determine an integrity of the kernel information using the attestation data including the configuration value and the extended value for attestation of the computing system. In some examples, the integrity of the kernel information can further be determined based on other values from the data structure, and further based on the log that is received as part of the attestation data.

In some examples, the determining of the integrity of the kernel information includes comparing the configuration value to a stored value to confirm that the monitoring configuration information is valid.

In some examples, the attestation data further includes a change indication value from the data structure. An example of the change indication value is from PCR[0] in FIG. 1. The change indication value is set to a specified value (e.g., “modified” value) by the kernel integrity monitoring controller responsive to detecting a change to the kernel information. The determining of the integrity of the kernel information further uses the change indication value.

In some examples, the change indication value is set to the specified value by the kernel integrity monitoring controller further responsive to a potential error condition in the computing system. The potential error condition can be based on detecting a number of instances of the kernel integrity monitoring controller being blocked from accessing the memory of the computing system to perform scanning of the kernel information. As noted above, an IOMMU in the computing system may block the memory access.

In some examples, the attestation data further includes a scanning indication value from the data structure. An example of the scanning indication value is from PCR[3] in FIG. 1. The scanning indication value is set to a first value (e.g., “active” value) if the kernel integrity monitoring controller is actively scanning the kernel information, and the scanning indication value set to a different second value (e.g., “inactive” value) if the kernel integrity monitoring controller is not actively scanning the kernel information. The determining of the integrity of the kernel information further uses the scanning indication value.

In some examples, the attestation data received at the verifier system from the computing system further includes the log. The machine-readable instructions upon execution cause the verifier system to replay the log to generate an extended value, and verify an authenticity of the log based on comparing the generated extended value to the extended value (e.g., from PCR[2]) in the attestation data.

In some examples, the machine-readable instructions identify changes to the kernel information based on the log received from the computing system.

In some examples, the log includes a time entry containing time information indicating a delay between a start time of the computing system and a time when the configuration information was received at the kernel integrity monitoring controller.

In some examples, the attestation indication from the verifier system to the computing system comprises a nonce, and the attestation data received at the verifier system from the computing system further includes a signature based on the nonce, a key, and the information from the data structure. The machine-readable instructions upon execution cause the verifier system to authenticate the attestation data using the signature.

In some examples, the attestation data is received at the verifier system from an agent (e.g., the attestation agent 114 of FIG. 1) executed on the CPU in the computing system. The kernel integrity monitoring controller has no access to any network.

In some examples, the monitoring configuration information identifies one or more kernel modules that are dynamically loadable by the kernel without triggering the kernel integrity monitoring controller to indicate a kernel information change in the data structure.

In some examples, the monitoring configuration information specifies a scanning condition for measurement of the kernel information.

In some examples, the scanning condition includes one or more of a frequency of scanning the kernel information by the kernel integrity monitoring controller, a triggering event to trigger scanning the kernel information by the kernel integrity monitoring controller, or an allowed list of kernel modules that if loaded do not trigger a change indication by the kernel integrity monitoring controller.

FIG. 5 is a block diagram of a KIMC 500 according to some examples. The KIMC 500 may be the KIMC 120 of FIG. 1.

The KIMC 500 includes a memory 502 to store a data structure 503 including information for forming attestation data for attestation of a computing system. An example of the data structure 503 includes PCRs, such as PCR[0], PCR[1], PCR[2], and PCR[3] in FIG. 1.

The KIMC 500 includes a controller processor 504 to perform various tasks. A processor performing a task can refer to a single processor performing the task or multiple processors performing the task.

The tasks of the controller processor 504 include a kernel information scanning task 506 to scan kernel information in a memory of the computing system. The controller processor 504 can be provided with target storage location information identifying regions of the memory of the computing system storing the kernel information.

The tasks of the controller processor 504 include a kernel information modification handling task 508 to, based on detecting a modification of the kernel information, add an entry to a log (e.g., the measurement log 130 of FIG. 1) and generate an extended measurement value in the data structure 503 (e.g., in PCR[2]) by extending a current measurement value in the data structure 503 with a measurement value in the added entry of the log.

The tasks of the controller processor 504 include an attestation request reception task 510 to receive, from an attestation agent (e.g., 114 in FIG. 1) executed on a CPU of the computing system, a request for the attestation data.

The tasks of the controller processor 504 include an attestation data generation task 512 to, responsive to the request, retrieve values from the data structure 503, the values including a configuration value (e.g., in PCR[1] in FIG. 1) derived based on applying a function (e.g., a cryptographic hash function) on monitoring configuration information (e.g., 156 in FIG. 1). The monitoring configuration information specifies a configuration for monitoring kernel information associated with a kernel executing on the CPU. The retrieved values also include the extended measurement value.

The tasks of the controller processor 504 include an attestation data sending task 514 to send the attestation data including the retrieved values to the attestation agent for forwarding to a verifier system over a network to determine an integrity of the kernel information using the configuration value and the extended value for the attestation of the computing system.

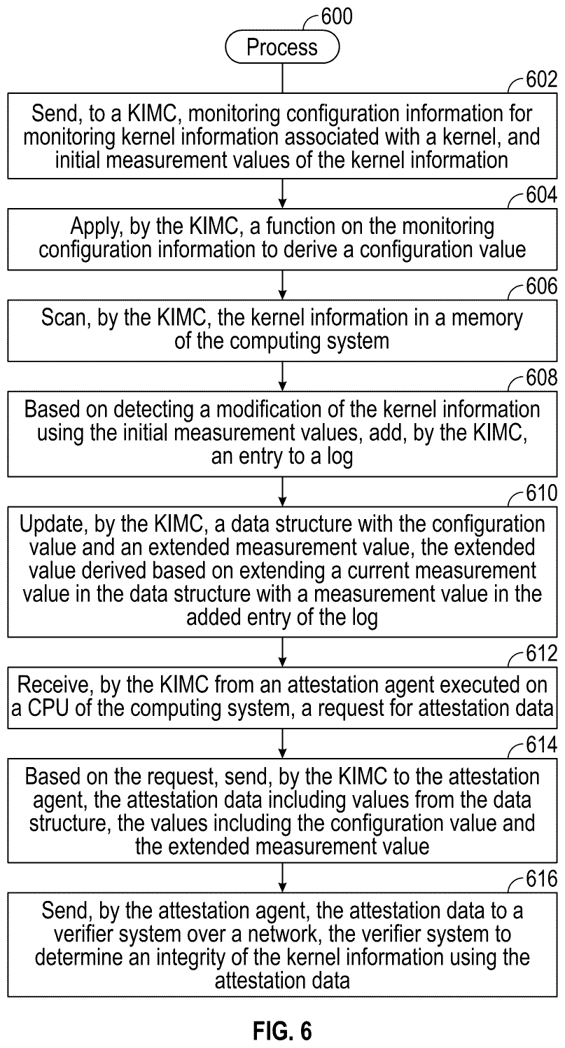

FIG. 6 is a flow diagram of a process 600 performed by a computing system, such as the computing system 104 or 106 of FIG. 1.

The process 600 includes sending (at 602), to a KIMC (e.g., 120 in FIG. 1), monitoring configuration information for monitoring kernel information associated with a kernel, and initial measurement values of the kernel information. The initial measurement values are generated by initial load-time measurements in the computing system.

The process 600 includes applying (at 604), by the KIMC, a function on the monitoring configuration information to derive a configuration value. The function can be a cryptographic hash function.

The process 600 includes scanning (at 606), by the KIMC, the kernel information in a memory of the computing system. The scanning is based on target storage location information of memory region(s) of the memory of the computing system.

The process 600 includes, based on detecting a modification of the kernel information using the initial measurement values, adding (at 608), by the KIMC, an entry to a log. An example of the log is the measurement log 130 of FIG. 1.

The process 600 includes updating (at 610), by the KIMC, a data structure with the configuration value and an extended measurement value, the extended value derived based on extending a current measurement value in the data structure with a measurement value in the added entry of the log. The update of the data structure can include updating PCRs in the data structure.

The process 600 includes receiving (at 612), by the KIMC from an attestation agent executed on a CPU of the computing system, a request for attestation data. The request can be a quote request or another type of request.

The process 600 includes, based on the request, sending (at 614), by the KIMC to the attestation agent, the attestation data including values from the data structure, the values including the configuration value and the extended measurement value. The values may further include other values from the data structure.

The process 600 includes sending (at 616), by the attestation agent, the attestation data to a verifier system over a network, the verifier system to determine an integrity of the kernel information using the attestation data.

Using techniques or mechanisms according to some implementations of the present disclosure, attestation of a computing system based on measurements by a KIMC is possible even if the KIMC does not have access to a network connected to a target entity to which alerts of kernel modifications are to be sent.

A “BMC” (which can be used to implement the KIMC 120 of FIG. 1) can refer to a specialized service controller that monitors the physical state of a computing system using sensors. The BMC can perform management tasks to manage components of the computing system. Examples of management tasks that can be performed by the BMC can include any or some combination of the following: power control to perform power management of the computing system (such as to transition the computing system between different power consumption states in response to detected events), thermal monitoring and control of the computing system (such as to monitor temperatures of the computing system and to control thermal management states of the computing system), fan control of fans in the computing system, system health monitoring based on monitoring measurement data from various sensors of the computing system, remote access of the computing system (to access the computing system over a network, for example), remote reboot of the computing system (to trigger the computing system to reboot using a remote command), system setup and deployment of the computing system, system security to implement security procedures in the computing system, and so forth.

In some examples, the BMC can run on auxiliary power provided by an auxiliary power supply (e.g., a battery); as a result, the computing system does not have to be powered on to allow the BMC to perform the BMC's operations. The auxiliary power supply is separate from a main power supply that supplies powers to other components (e.g., a main processor, a memory, an input/output (I/O) device, etc.) of the computing system.

As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

A hardware processor (such as part of the CPU 110 or part of the controller processor 140 of FIG. 1) can include a microprocessor, a core of a multi-core microprocessor, a microcontroller, a programmable integrated circuit, a programmable gate array, or another hardware processing circuit.

A storage medium (e.g., 400 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a verifier system to:
receive, at the verifier system over a network from a computing system, attestation data comprising information from a data structure stored in a kernel integrity monitoring controller, the information from the data structure comprising:
a configuration value derived based on applying a function on monitoring configuration information, the monitoring configuration information specifying a configuration for monitoring kernel information associated with a kernel executing on a central processing unit (CPU) of the computing system, wherein the CPU is separate from the kernel integrity monitoring controller, and
an extended value derived based on extending a prior value in the data structure with a new value from a log recording changed measurements of the kernel information; and
determine an integrity of the kernel information using the configuration value and the extended value for attestation of the computing system.

2. The non-transitory machine-readable storage medium of claim 1, wherein the determining of the integrity of the kernel information comprises comparing the configuration value to a stored value to confirm that the monitoring configuration information is valid.

3. The non-transitory machine-readable storage medium of claim 1, wherein the attestation data further comprises a change indication value from the data structure, the change indication value set to a specified value by the kernel integrity monitoring controller responsive to detecting a change to the kernel information, and
wherein the determining of the integrity of the kernel information further uses the change indication value.

4. The non-transitory machine-readable storage medium of claim 3, wherein the change indication value is set to the specified value by the kernel integrity monitoring controller further responsive to a potential error condition in the computing system.

5. The non-transitory machine-readable storage medium of claim 1, wherein the attestation data further comprises a scanning indication value from the data structure, the scanning indication value set to a first value if the kernel integrity monitoring controller is actively scanning the kernel information, and the scanning indication value set to a different second value if the kernel integrity monitoring controller is not actively scanning the kernel information, and
wherein the determining of the integrity of the kernel information further uses the scanning indication value.

6. The non-transitory machine-readable storage medium of claim 1, wherein the attestation data received at the verifier system from the computing system further comprises the log, and wherein the instructions upon execution cause the verifier system to:
replay the log to generate an extended value; and
verify an authenticity of the log based on comparing the generated extended value to the extended value in the attestation data.

7. The non-transitory machine-readable storage medium of claim 6, wherein the instructions upon execution cause the verifier system to:
identify changes to the kernel information based on the log received from the computing system.

8. The non-transitory machine-readable storage medium of claim 7, wherein the log comprises time information indicating a delay between a start time of the computing system and a time when the monitoring configuration information was received at the kernel integrity monitoring controller.

9. The non-transitory machine-readable storage medium of claim 1, wherein the instructions upon execution cause the verifier system to:
send an attestation indication from the verifier system to the computing system over the network, the attestation indication to initiate the attestation of the computing system, wherein the attestation indication comprises a nonce, and the attestation data received at the verifier system from the computing system further comprises a signature based on the nonce, a key, and the information from the data structure; and
authenticate the attestation data using the signature.

10. The non-transitory machine-readable storage medium of claim 1, wherein the data structure comprises a plurality of platform configuration registers (PCRs), wherein the configuration value is in a first PCR of the plurality of PCRs, and the extended value is in a second PCR of the plurality of PCRs.

11. The non-transitory machine-readable storage medium of claim 1, wherein the extended value is derived based on:
computing a cryptographic hash of the new value from the log to derive a first hash value, wherein the prior value is a second hash value, and
computing a cryptographic hash of a combination of the first hash value and the second hash value to produce the extended value.

12. The non-transitory machine-readable storage medium of claim 1, wherein the attestation data is received at the verifier system from an agent executed on the CPU in the computing system, and
wherein the kernel integrity monitoring controller has no access to any network.

13. The non-transitory machine-readable storage medium of claim 1, wherein the monitoring configuration information identifies one or more kernel modules that are dynamically loadable by the kernel without triggering the kernel integrity monitoring controller to indicate a kernel information change in the data structure.

14. The non-transitory machine-readable storage medium of claim 1, wherein the monitoring configuration information specifies a scanning condition for measurement of the kernel information.

15. The non-transitory machine-readable storage medium of claim 14, wherein the scanning condition comprises one or more of a frequency of scanning the kernel information by the kernel integrity monitoring controller, a triggering event to trigger scanning the kernel information by the kernel integrity monitoring controller, or an allowed list of kernel modules that if loaded do not trigger a change indication by the kernel integrity monitoring controller.

16. A kernel integrity monitoring controller comprising:
a memory to store a data structure comprising information for forming attestation data for attestation of a computing system; and
a controller processor to:
scan kernel information in a memory of the computing system;
based on detecting a modification of the kernel information:
add an entry to a log, and
generate an extended measurement value in the data structure by extending a current measurement value in the data structure with a measurement value in the added entry of the log;
receive, from an attestation agent executed on a central processing unit (CPU) of the computing system, a request for the attestation data, wherein the kernel integrity monitoring controller is separate from the CPU;
responsive to the request, retrieve values from the data structure, the values comprising:
a configuration value derived based on applying a function on monitoring configuration information, the monitoring configuration information specifying a configuration for monitoring kernel information associated with a kernel executing on the CPU, and
the extended measurement value; and
send the attestation data comprising the retrieved values to the attestation agent for forwarding to a verifier system over a network to determine an integrity of the kernel information using the configuration value and the extended measurement value for the attestation of the computing system.

17. The kernel integrity monitoring controller of claim 16, wherein the controller processor is to:
receive the monitoring configuration information from the attestation agent; and
compute the configuration value by applying the function on the monitoring configuration information received from the attestation agent.

18. The kernel integrity monitoring controller of claim 16, wherein the attestation data further comprises:
the log, and
a change indication value from the data structure, the change indication value set to a specified value by the kernel integrity monitoring controller responsive to detecting a change to the kernel information.

19. A method of a computing system, comprising:
sending, to a kernel integrity monitoring controller, monitoring configuration information for monitoring kernel information associated with a kernel, and initial measurement values of the kernel information;
applying, by the kernel integrity monitoring controller, a function on the monitoring configuration information to derive a configuration value;
scanning, by the kernel integrity monitoring controller, the kernel information in a memory of the computing system;
based on detecting a modification of the kernel information using the initial measurement values, adding, by the kernel integrity monitoring controller, an entry to a log;
updating, by the kernel integrity monitoring controller, a data structure with the configuration value and an extended measurement value, the extended measurement value derived based on extending a current measurement value in the data structure with a measurement value in the added entry of the log
receiving, by the kernel integrity monitoring controller from an attestation agent executed on a central processing unit (CPU) of the computing system, a request for attestation data, wherein the kernel integrity monitoring controller is separate from the CPU;
based on the request, sending, by the kernel integrity monitoring controller to the attestation agent, the attestation data including values from the data structure, the values comprising the configuration value and the extended measurement value; and
sending, by the attestation agent, the attestation data to a verifier system over a network, the verifier system to determine an integrity of the kernel information using the attestation data.

20. The method of claim 19, wherein the attestation data further includes the log.
